(19) United States
(12) Patent Application Publication
(10) Pub. No.: US 2011/0167828 A1
(43) Pub. Date: Jul. 14, 2011

(54) COMBUSTOR ASSEMBLY FOR A TURBINE ENGINE THAT MIXES COMBUSTION PRODUCTS WITH PURGE AIR

(76) Inventors: Arjun Singh, Bangalore (IN); Gilbert Otto Kraemer, Greer, SC (US)

(21) Appl. No.: 12/684,153

(22) Filed: Jan. 8, 2010

(51) Int. Cl. F02C 7/22; F02C 7/00

(52) U.S. Cl. 60/740; 60/760

(57) ABSTRACT

A combustor assembly for a turbine engine includes a fuel nozzle located at an upstream end of the combustor assembly. The fuel nozzle includes both a fuel delivery passageway and a purge air passageway. The purge air passageway conveys a flow of purge air to cool the fuel nozzle. The combustor assembly also includes a combustion product return line that conveys a flow of combustion products from a position downstream of a combustion zone of the combustor back to the fuel nozzle. The combustion products are mixed with purge air, and the mixture is delivered into a combustion zone located just downstream of the fuel nozzle. The addition of the combustion products into the purge air reduces the amount of oxygen in mixed flow, which helps to reduce the generation of undesirable nitrogen oxide combustion byproducts. Also, the greater heat of the combustion products helps to increase the temperature of the mixture, which helps to maintain the stability of a pilot flame fed by the mixture.

### BACKGROUND OF THE INVENTION

Turbine engines used in the electrical power generation industry typically include a compressor section which is surrounded by a plurality of combustors. In each combustor, compressed air from the compressor section of the turbine is introduced into an interior of a combustor liner. The compressed air is mixed with fuel, and the air-fuel mixture is then ignited. The combustion gases then pass out of the combustor and into the turbine section of the engine.

Fuel nozzles are mounted at the upstream end of the combustor liner, and the fuel nozzles deliver fuel into the flow of compressed air to create the air-fuel mixture that is burned. The fuel nozzles can include primary fuel nozzles that are arranged in an annular ring around the combustor, and a secondary fuel nozzle that is located in the center of the combustor. Typically, the primary fuel nozzles will deliver an air-fuel mixture into a primary combustion zone. The secondary fuel nozzle, which extends further down the length of the combustor than the primary fuel nozzles, will deliver an air-fuel mixture into a secondary combustion zone that is located farther down the length of the combustor than the primary combustion zone.

The secondary fuel nozzle may include a pilot fuel delivery passageway that delivers fuel to a “pilot flame,” located just downstream of the end of the secondary fuel nozzle. The pilot flame is intended to be quite stable such that the pilot flame will always remain lit, regardless of what is happening in the primary and secondary combustion zones of the combustor. However, the pilot flame is known to be a significant contributor to undesirable combustion byproducts, such as oxides of Nitrogen (NOx).

### BRIEF DESCRIPTION OF THE INVENTION

In a first aspect, the invention may be embodied in a combustor assembly for a turbine engine that includes a combustor liner, a combustor cap located at a head end of the combustor liner, and at least one fuel nozzle mounted on the combustor cap. The at least one fuel nozzle includes at least one purge air passageway. The combustor assembly also includes a combustion product return line having a first end that opens into an interior of the combustor at a position downstream of a combustion zone of the combustor. A second end of the combustion product return line is coupled to the at least one fuel nozzle. The combustion product return line conveys a flow of combustion products from a position downstream of the combustion zone to the at least one fuel nozzle. The combustion products from the combustion product return line are mixed with purge air in the at least one purge air passageway of the at least one fuel nozzle

In a second aspect, the invention may be embodied in a fuel nozzle for a combustor assembly of a turbine engine that includes a housing, at least one fuel delivery passageway located within the housing, at least one purge air passageway located within the housing, and a combustion product receiving fitting. The fuel nozzle mixes purge air with combustion products received through the combustion product receiving fitting. The fuel nozzle also conveys the mixture of purge air and combustion products along the at least one purge air passageway.

In another aspect, the invention may be embodied in a method of operating a fuel nozzle of a turbine engine that includes conveying a flow of purge air to the fuel nozzle, conveying a flow of combustion products from a location downstream of the fuel nozzle back to the fuel nozzle, mixing the purge air and the combustion products, and conveying the mixture of purge air and combustion products through a purge air passageway of the fuel nozzle.

### BRIEF DESCRIPTION OF THE DRAWINGS

FIG. 1 is a cross-sectional view illustrating a first embodiment of a combustor assembly for a turbine engine;

FIG. 2 is a cross-sectional view illustrating a second embodiment of a combustor assembly for a turbine engine;

FIG. 3 is a cross-sectional view illustrating a third embodiment of a combustor assembly for a turbine engine;

FIG. 4 is a cross-sectional view illustrating a fourth embodiment of a combustor assembly for a turbine engine.

FIG. 5 is a cross sectional view showing a first embodiment of a fuel nozzle;

FIG. 6 is a cross sectional view showing a second embodiment of a fuel nozzle; and

FIG. 7 is a cross sectional view showing a third embodiment of a fuel nozzle.

### DETAILED DESCRIPTION OF PREFERRED EMBODIMENTS

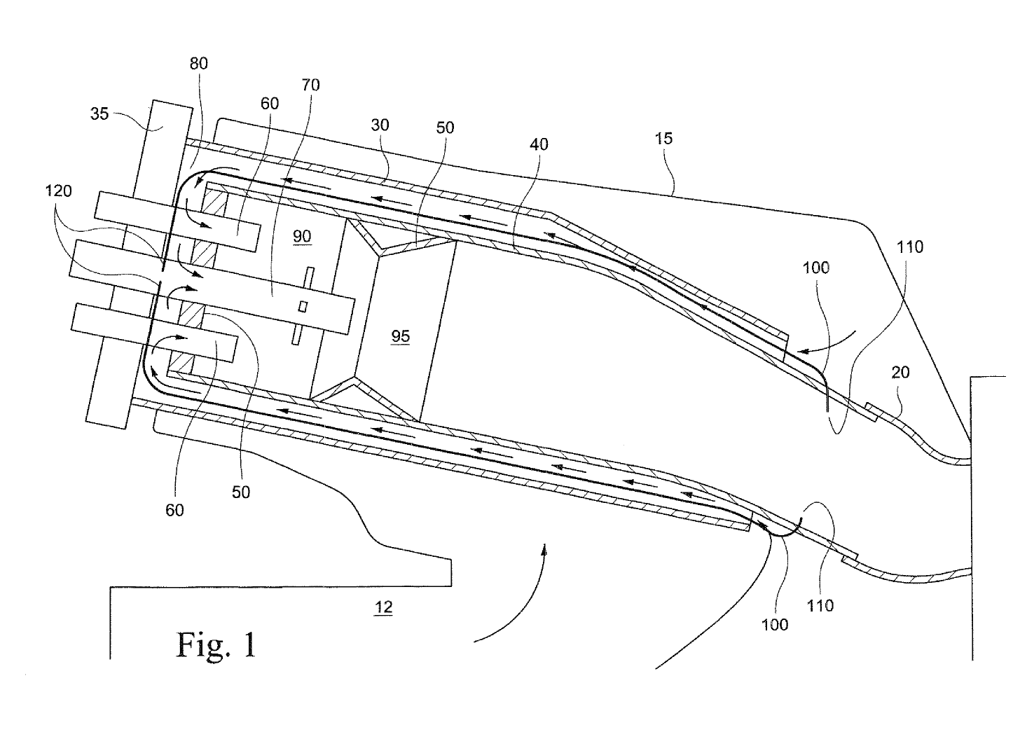

A typical combustor assembly for a turbine engine is illustrated in FIG. 1. As shown therein, the combustor includes a transition duct 20 which routes combustion gases into the turbine section of the turbine engine. The transition duct 20 is attached to a downstream end of a combustor liner 40. A flow sleeve 30 surrounds the exterior of the combustor liner 40.

Compressed air from the compressor section 12 of the turbine is routed into the annular space between the combustor liner 40 and the flow sleeve 30. The arrows in FIG. 1 illustrate the direction of movement of the compressed air. As shown in FIG. 1, the compressed air moves along the annular space between the combustor liner 40 and the flow sleeve 30 to the upstream end of the combustor. The compressed air then turns and enters the space inside the combustor liner 40.

A plurality of fuel nozzles 60, 70 are located at the upstream end of the combustor. Multiple primary fuel nozzles 60 are mounted in an annular ring around a combustor cap 50. In addition, at least one secondary fuel nozzle 70 is located in the center of the upper end of the combustor. As shown in FIG. 1, the secondary fuel nozzle 70 typically extends a greater distance down the length of the combustor.

Combustion within the combustor typically takes place in two different locations. There is a primary combustion zone 90 located at the far upstream end of the combustor and adjacent the discharge ends of the primary fuel nozzles 60. In addition, there is a secondary combustion zone 95 located further down the length of the combustor and adjacent a discharge end of the secondary fuel nozzle 70. In some combustors, a venturi is formed between the primary combustion zone 90 and the secondary combustion zone 95 by angled walls 50. The angled walls neck in to reduce an interior diameter of the combustor. The venturi formed by the angled walls 50 increases the speed of the air and fuel passing through this section of the combustor immediately before the air-fuel mixture enters the secondary combustion zone 95.

During an initial start up procedure, fuel is delivered into the combustor through both the primary fuel nozzles 60 and the secondary fuel nozzle 70. The air-fuel mixture is ignited in both the primary combustion zone 90 and the secondary combustion zone 95. The operating speed of the turbine is increased and a load, typically in the form of an electrical power generator, is placed on the turbine.

To achieve optimum efficiency, it is desirable for combustion to take place only in the secondary combustion zone 95. Thus, although it is necessary to initially have combustion occurring in both the primary combustion zone 90 and the secondary combustion zone 95, at some point during the start up procedure it is necessary to eliminate combustion in the primary combustion zone 90.

In order to eliminate combustion in the primary combustion zone 90, it is necessary to temporarily cut off fuel to the primary fuel nozzles 60. During this transition time period, fuel is still delivered into the secondary combustion zone 95 through the secondary fuel nozzle 70. Once fuel has been cut to the primary fuel nozzles 60 for a period of time, combustion in the primary combustion zone 90 will cease, and combustion will only continue to take place in the secondary combustion zone 95. At this point in time, fuel may again be introduced through the primary fuel nozzles. The fuel introduced via the primary fuel nozzle will mix the compressed air and pass into the secondary combustion zone 95 before being ignited and burned.

The secondary fuel nozzle 70 will typically include a pilot fuel delivery passageway which feeds fuel to a pilot flame located just downstream of the secondary fuel nozzle 70. The pilot flame is intended to be a very stable flame which will remain lit during the changeover process described above. The secondary fuel nozzle may also include one or more purge air passageways which deliver purge air through the secondary fuel nozzle 70. The purge air is typically compressed air tapped from the compressor section 12 of the turbine engine. The purge air flowing along the length of the secondary fuel nozzle 70 helps to cool the fuel nozzle. This purge air then mixes with the fuel delivered by the secondary fuel nozzle in the secondary combustion 95 and the air-fuel mixture is burned in the secondary combustion zone 95.

The combustor assembly illustrated in FIG. 1 also includes a plurality of combustion product return lines 100. The combustion product return lines have a first end 110 located at the downstream end of the combustor liner 40. The first ends 110 of the combustion product return lines 100 open into the interior of the combustor liner. Second ends 120 of the combustion product return lines 100 are coupled to the secondary fuel nozzle 70 at the upstream end of the combustor assembly. The combustion product return lines 110 are intended to convey a flow of combustion products resulting from the burning of the air-fuel mixture from the downstream end of the combustion assembly back into the secondary fuel nozzle 70.

The combustion products received at the secondary fuel nozzle 70 are mixed with the purge air passing along the purge air passageways of the secondary fuel nozzle. The mixture of the purge air and the combustion products is then delivered into the secondary combustion zone 95 from the downstream end of the secondary fuel nozzle 70.

As explained above, the pilot flame is fed fuel by a pilot fuel passageway in the secondary fuel nozzle 70. The pilot flame also receives air, in the form of the purge air, which passes along the purge air passageways of the secondary nozzle. The pilot flame is responsible for generating a significant amount of nitrogen oxide combustion by-products, which are generally undesirable. By mixing combustion products with the purge air, the oxygen concentration of the air-fuel mixture being burned by the pilot flame is reduced compared to an air-fuel mixture which includes only the purge air alone. A reduction in the oxygen concentration of the air-fuel mixture being burned by the pilot flame reduces the generation of undesirable nitrogen oxide by-products by the pilot flame. Nitrogen oxide by-products are also reduced by re-burning the recirculated nitrogen oxides from the original combustion products. Moreover, nitrogen oxide reductions may also occur because of a reduction of nitrogen oxides to just nitrogen in the pilot flame front.

In addition, the high temperature of the combustion products results in an overall increase in the temperature of the air-fuel mixture being fed to the pilot flame, as compared to an air-fuel mixture which includes only the purge air alone. This increase in the temperature of the air-fuel mixture being burned by the pilot flame helps to ensure the stability of the pilot flame, which might otherwise be negatively affected by a reduction in the oxygen concentration of the air-fuel mixture.

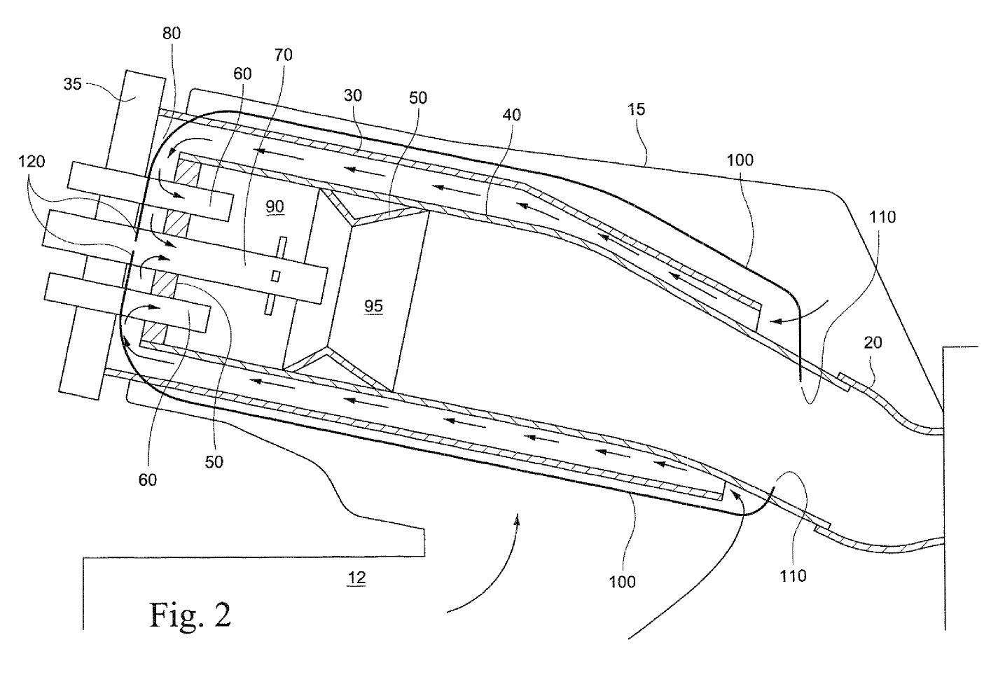

In the embodiment illustrated in FIG. 1, the combustion product return lines 100 are routed through the annular space located between the combustor liner 40 and the flow sleeve 30. In an alternate embodiment, as illustrated in FIG. 2, the combustion product return lines 100 are routed along an exterior of the flow sleeve 30. This would locate the combustion product return lines 100 between the flow sleeve 30 and the casing 15.

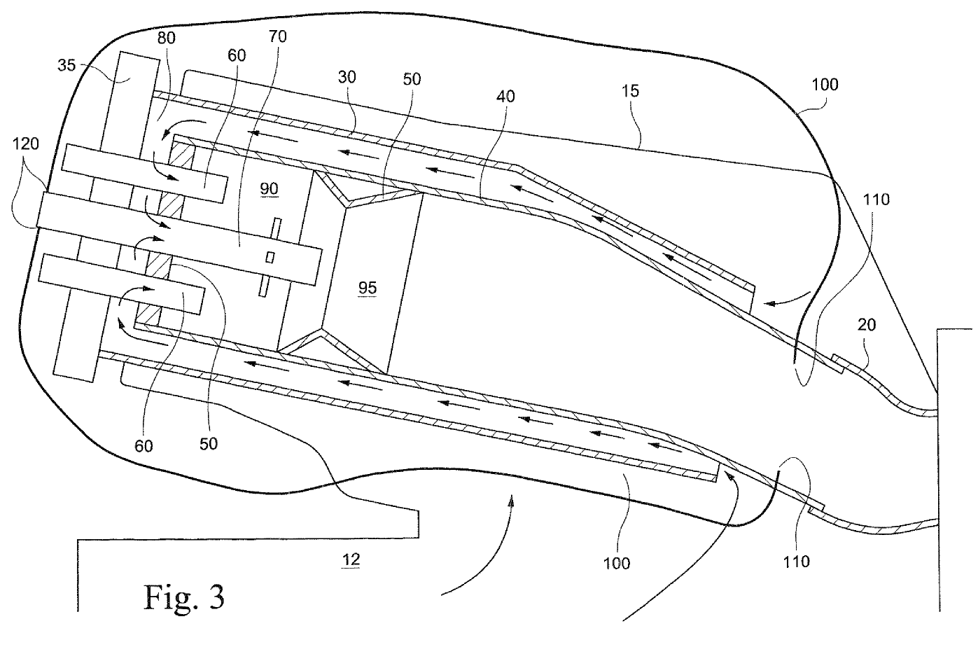

In yet another embodiment, as illustrated in FIG. 3, the combustion product return lines 100 are routed to the exterior of the casing 15. In this embodiment, the second ends 120 of the combustion product return lines 100 could be attached to a portion of the secondary fuel nozzle 70 which is located outside the combustor assembly.

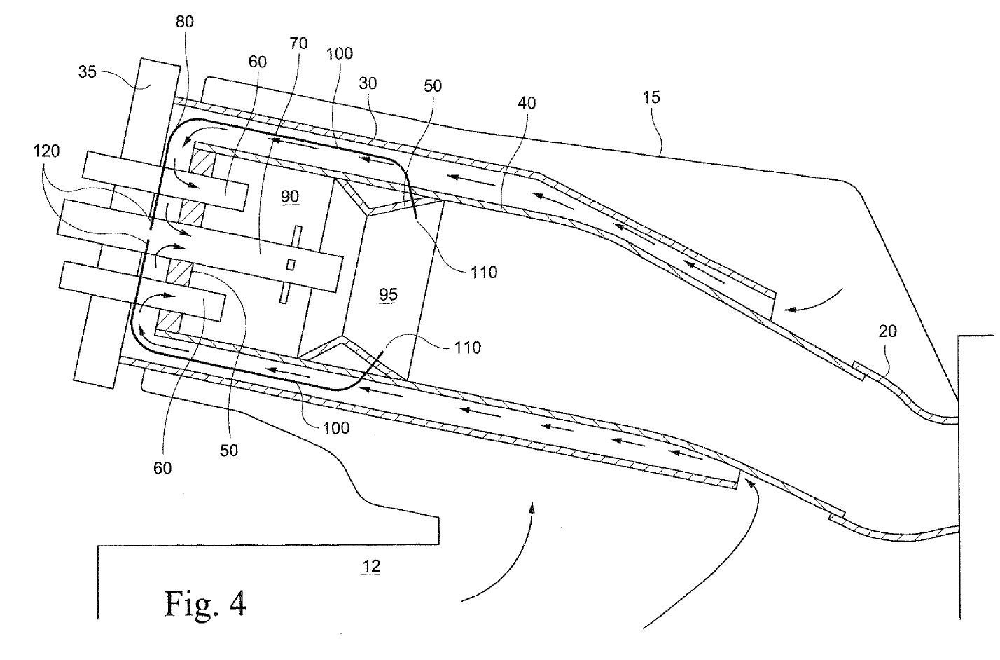

In another embodiment, as illustrated in FIG. 4, the combustion product return lines 100 are routed through the annular space located between the combustor liner 40 and the flow sleeve 30. However, in this embodiment, the first ends 110 of the combustion product return lines 100 are located just aft of the venturi in the combustor. In other alternate embodiments, the first ends 110 of the combustion product return lines could be located at a variety of different locations, so long as the first ends 110 of the combustion product return lines are capable of receive combustion products.

Although FIGS. 1-4 illustrate a plurality of combustion product return lines, in any given embodiment of a combustor assembly, there might be only a single combustion product return line, or there may be more than two combustion product return lines. The number and arrangement of the combustion product return lines could be varied to satisfy a variety of different design considerations.

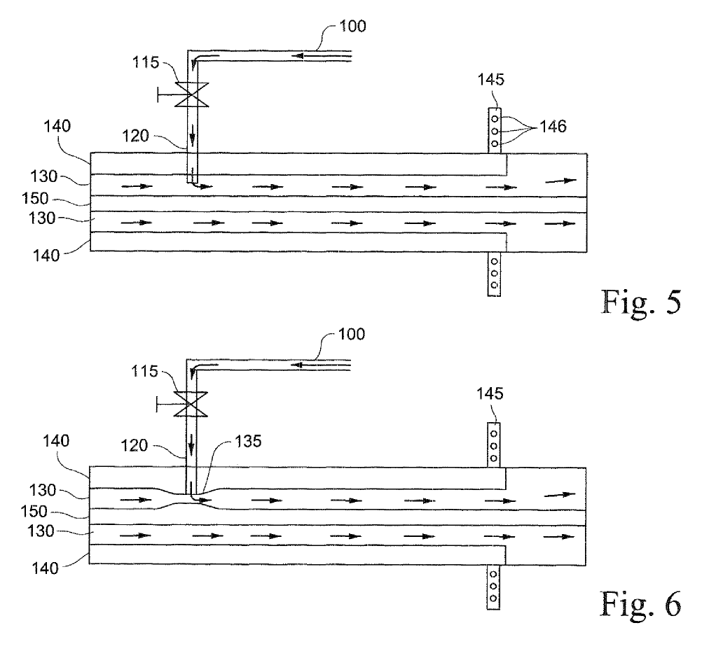

FIG. 5 illustrates how a combustion product return line could be interfaced to a secondary fuel nozzle. As shown in FIG. 5, the secondary fuel nozzle includes a housing enclosing fuel delivery passageways 140 and purge air passageways 130. A pilot fuel passageway 150 may be located at the center of the fuel nozzle. In addition, a plurality of fuel injectors 145 may be located around the exterior of the downstream end of the fuel nozzle. Fuel from the fuel delivery passageways 140 would be delivered into the fuel injectors 145, and the fuel would exit through a plurality of fuel apertures 146 on the fuel injectors 145. The fuel ejected through the fuel apertures 146 would then mix with a flow of compressed air flowing down the length of the fuel nozzle.

In the embodiment illustrated in FIG. 5, the second end 120 of a combustion product return line 100 could simply open into one of the purge air passageways 130 of the fuel nozzle. A pressure of the combustion products at the downstream end of the combustor liner, where the first ends 110 of the combustion product return lines 100 are located, is greater than a pressure within the purge air passageway 130. This ensures that a flow of combustion products will move along the combustion product return lines 100 from first ends 110 located at the downstream end of the combustor assembly back to the first ends 120 which open into the secondary fuel nozzle.

In some embodiments, a combustion product return valve 115 may be located along the combustion product return lines 100. The combustion product return valve 115 would be used to control the flow of the combustion products through the combustion product return lines 100 and into the purge air passageway 130 of the secondary fuel nozzle.

FIG. 6 illustrates a secondary fuel nozzle similar to the one illustrated in FIG. 5. However, in the embodiment illustrated in FIG. 6, a venturi 135 is formed along the purge air passageway 130. The venturi 135 will cause the speed of the purge air in the purge air passageway 130 to increase at the venturi as a result of the decrease in pressure. The reduction in pressure at the venturi 135 would help to draw the combustion products along the combustion product return lines 100 and into the purge air passageway 130.

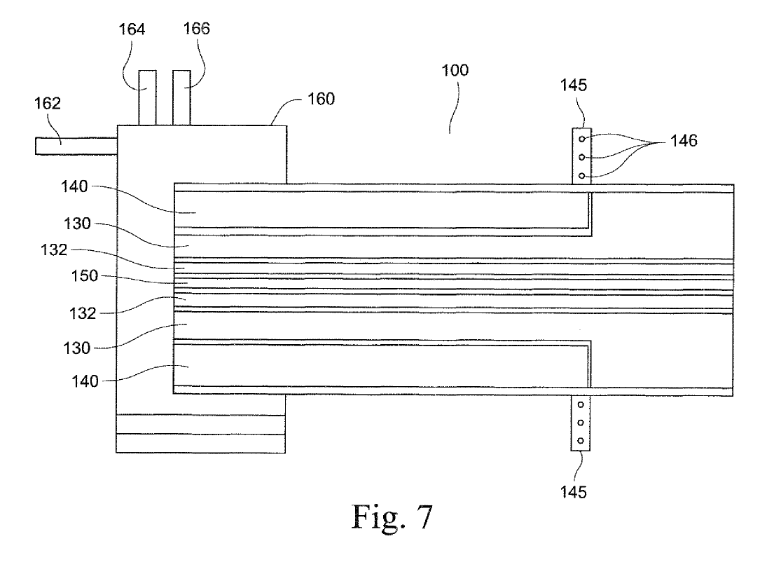

Another embodiment of a fuel nozzle is illustrated in FIG. 7. In this embodiment, a manifold 150 is provided at the upstream end of the fuel nozzle. The nozzle includes fuel delivery passageways 140 and purge air passageways 130. A plurality of passageways 132, 150 are located at a center of the nozzle. These passageways could be used as purge air passageways or as pilot fuel delivery passageways depending on how the nozzle is to be configured.

A fuel supply line 162 is coupled to the manifold. In addition, a purge air supply line 164 and a combustion product supply line 166 are also attached to the manifold 150. The manifold 150 would then deliver fuel from the fuel supply line 162 into the appropriate fuel delivery passageways of the nozzle. In addition, the manifold 150 would act to deliver purge air from the purge air supply line 164 into the purge air passageways of the fuel nozzle. Further, the manifold 150 would deliver combustion products from the combustion product supply line 166 into one or more of the purge air passageways of the fuel nozzle. The manifold 150 could act to selectively control the amount of combustion products being delivered into the purge air passageways of the fuel nozzle.

In some embodiments, combustion products from the combustion product supply line 166 would be routed into only a single one of the purge air passageways of the fuel nozzle. In alternate embodiments, the manifold may route combustion products from the combustion product supply line 166 into multiple ones of the purge air passageways of the fuel nozzle.

In the embodiment illustrated in FIG. 7, only a single combustion product supply line 166 is coupled into the manifold 150. However, in alternate embodiments a plurality of combustion product supply lines could be coupled to the manifold 150.

Likewise, in any particular embodiment of a secondary fuel nozzle, the fuel nozzle could be coupled to one or to multiple combustion product supply lines. Also, regardless of the number of combustion product supply lines that are connected, the fuel nozzle could deliver the combustion products into one purge air passageway, or into multiple purge air passageways.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A combustor assembly for a turbine engine, comprising:
a combustor liner;
a combustor cap located at a head end of the combustor liner;
at least one fuel nozzle mounted on the combustor cap, wherein the at least one fuel nozzle includes at least one purge air passageway; and
a combustion product return line having a first end that opens into an interior of the combustor at a position downstream of a combustion zone of the combustor, and having a second end that is coupled to the at least one fuel nozzle, wherein the combustion product return line conveys a flow of combustion products from a position downstream of the combustion zone to the at least one fuel nozzle, and wherein the combustion products from the combustion product return line are mixed with purge air in the at least one purge air passageway of the at least one fuel nozzle.

2. The combustor assembly of claim 1, wherein the second end of the combustion product return line opens into the at least one purge air passageway.

3. The combustor assembly of claim 2, further comprising a combustion product return valve coupled to the combustion product return line, wherein the combustion product return valve regulates a flow of combustion products passing through the combustion product return line.

4. The combustor assembly of claim 1, wherein a venturi is formed in a portion of the at least one purge air passageway, and wherein the second end of the combustion product return line opens into the venturi.

5. The combustor assembly of claim 4, further comprising a combustion product return valve coupled to the combustion product return line, wherein the combustion product return valve regulates a flow of combustion products passing through the combustion product return line.

6. The combustor assembly of claim 1, further comprising a combustion product return valve coupled to the combustion product return line, wherein the combustion product return valve regulates a flow of combustion products passing through the combustion product return line.

7. The combustor assembly of claim 1, wherein the combustion product return line comprises a plurality of combustion product return lines.

8. The combustor assembly of claim 1, wherein the at least one purge air passageway comprises a plurality of purge air passageways.

9. The combustor assembly of claim 8, wherein each of the plurality of purge air passageways is coupled to the combustion product return line.

10. The combustor assembly of claim 1, wherein the at least one fuel nozzle includes a manifold, wherein the manifold is coupled to a purge air supply line and the combustion product return line, and wherein the manifold delivers both purge air from the purge air supply line and combustion products from the combustion product return line into the at least one purge air passageway.

11. A fuel nozzle for a combustor assembly of a turbine engine, comprising:
a housing;
at least one fuel delivery passageway located within the housing;
at least one purge air passageway located within the housing; and
a combustion product receiving fitting, wherein the fuel nozzle mixes purge air with combustion products received through the combustion product receiving fitting, and wherein the nozzle conveys the mixture of purge air and combustion products along the at least one purge air passageway.

12. The fuel nozzle of claim 11, wherein the combustion product receiving fitting includes a passageway that opens into the at least one purge air passageway.

13. The fuel nozzle of claim 12, further comprising a combustion product return valve coupled to the combustion product receiving fitting, wherein the combustion product return valve regulates a flow of combustion products into the combustion product receiving fitting.

14. The fuel nozzle of claim 11, wherein a venturi is formed in the at least one purge air passageway, and wherein the combustion product receiving fitting includes a passageway that opens into the venturi.

15. The fuel nozzle of claim 11, further comprising a manifold that is coupled to a purge air supply line and to the combustion product receiving fitting, wherein the manifold delivers both purge air from the purge air supply line and combustion products received through the combustion product receiving fitting into the at least one purge air passageway.

16. The fuel nozzle of claim 11, wherein the at least one purge air passageway comprises a plurality of purge air passageways, and wherein the combustion product receiving fitting is coupled to each of the plurality of purge air passageways

17. The fuel nozzle of claim 11, wherein the combustion product receiving fitting comprises a plurality of combustion product receiving fittings.

18. The fuel nozzle of claim 11, wherein the combustion product receiving fitting is coupled to a plurality of combustion product return lines.

19. A method of operating a fuel nozzle of a turbine engine, comprising:
conveying a flow of purge air to the fuel nozzle;
conveying a flow of combustion products from a location downstream of the fuel nozzle back to the fuel nozzle;
mixing the purge air and the combustion products; and
conveying the mixture of purge air and combustion products through a purge air passageway of the fuel nozzle.

20. The method of claim 19, wherein the purge air passageway of the fuel nozzle includes a venturi, and wherein the mixing step comprises delivering the combustion products into the purge air passageway at the venturi.
